(19) United States
(12) Patent Application Publication
(10) Pub. No.: US 2023/0226541 A1
(43) Pub. Date: Jul. 20, 2023

(54) FLUID ABSORPTION TEST TUBE

(71) Applicant: Hollister Incorporated, Libertyville, IL (US)

(72) Inventors: Joel D. Shutt, Gurnee, IL (US); Jeremy R. Quint, Round Lake Beach, IL (US)

(21) Appl. No.: 17/577,866

(22) Filed: Jan. 18, 2022

(51) Int. Cl. B01L 3/00

(52) U.S. Cl. CPC B01L 3/5023; B01L 2200/026; B01L 2200/087; B01L 2300/069; B01L 2300/0609; B01L 2400/0457

(57) ABSTRACT

A test tube for testing fluid absorption of a sample material includes an elongated tubular portion configured to contain a test fluid and a base portion for receiving and holding the sample material. The base portion is in fluid communication with the elongated tubular portion and configured to support the elongated tubular portion when the test tube is in an upright position with the base portion placed on a surface. The test tube is configured such that when the sample material is received in the base portion and the test tube is placed in the upright position for a fluid absorption test, the test fluid contained in the elongated tubular portion makes contact with the sample material.

### BACKGROUND

This disclosure is related to a test tube. More particularly, the present disclosure pertains to a fluid absorption test tube.

Ostomy pouches for collecting bodily waste are used by individuals who have had surgery such as a colostomy, ileostomy, or urostomy. An ostomy pouch may be attached to a user via an ostomy skin barrier, which is configured to seal against peristomal skin surfaces and protect the peristomal surfaces from exposure to stomal effluent. There are many skin barrier options designed to provide a secure seal around a stoma, prevent leakage, and protect a user’s skin. Fluid absorption is an important property to consider when selecting a barrier material for ostomy applications. Thus, barrier materials are often tested for their fluid absorption properties. A syringe is typically used for testing fluid absorption of a barrier material, wherein a cylindrical tube or a barrel of the syringe is used to hold a test fluid and a barrier material sample is placed on the bottom opening of the barrel. The test assembly is placed on a flat surface with the barrier material facing the surface to expose the barrier material sample to the test fluid. However, using a syringe presents challenges since it is not designed to test fluid absorption. For example, the test assembly may become unstable as the barrier material sample absorbs the fluid and expand.

Accordingly, it is desirable to provide an improved test device for testing a fluid absorption of a material, such as a skin barrier material.

### BRIEF SUMMARY

A test tube for testing fluid absorption of a material, such as an ostomy skin barrier and adhesive, is provided according to various embodiments.

In one aspect, the test tube for testing fluid absorption of a sample material may include a base portion and an elongated tubular portion. The elongated tubular portion may be configured to contain test fluid. The base portion may be configured to be in fluid communication with the elongated tubular portion and support the elongated tubular portion when the test tube is in an upright position with the base portion placed on a surface. The base portion may also be configured to receive and contain the sample material. The test tube may be configured such that when the sample material is received in the base portion and the test tube is placed in the upright position for a fluid absorption test, the test fluid contained in the elongated tubular portion may contact the sample material.

In an embodiment, the base portion may include a first end and a second end. The first end may include a first opening for receiving the sample material. The second end may include a second opening. The elongated tubular portion may include a third end with a third opening and a fourth end with a fourth opening. The second end may be coupled to the third end. The diameter of the second opening may be less than the diameter of the first opening, and the diameter of the fourth opening may be less than a diameter of the first opening. The fourth opening may be configured to allow the test fluid to enter the elongated tubular portion and to flow to the base portion through the second and third opening.

The base portion may include an inner surface radially extending from and surrounding the second opening. The inner surface may be configured for attachment of the sample material. The sample material may be attached to the inner surface and cover the second opening when the sample material is received in the base portion, wherein the test fluid contained in the elongated tubular portion may make contact with the sample material through the second opening.

In an embodiment, the base portion and the elongated tubular portion may be integrally formed as a single-piece device, wherein the second opening and the third opening may be formed as a single continuous opening

In an embodiment, the base portion may include a tubular structure with a diameter greater than or equal to the diameter of the first opening.

In an embodiment, the first opening may be a substantially circular opening and the sample material may have a substantially circular body, wherein the diameter of the first opening is greater than or equal to the diameter of the sample material.

In an embodiment, the elongated tubular portion may include a tubular structure with an interior diameter less than an interior diameter of the base portion. The elongated tubular portion may be configured to hold at least about 10 ml of the test fluid.

In an embodiment, a surface of the elongated tubular portion may include a textured area for improving grip. The textured area may be located away from the third end.

In an embodiment, the elongated tubular portion may be supported by the base portion in an upright position and the test fluid in the elongated tubular portion may make contact with the sample material without leaking out of the base portion.

In an embodiment, the sample material may be formed from an ostomy skin barrier material.

In an embodiment, the test tube may be formed from polycarbonate.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 is a perspective view of a test tube according to an embodiment.

FIG. 2 is a cross-sectional view of the test tube of FIG. 1.

FIG. 3 is a bottom perspective view of the test tube of FIG. 1.

FIG. 4 is a perspective view of a test sample according to an embodiment.

FIG. 5 is a perspective view of the test tube of FIG. 1 and the test sample of FIG. 4.

FIG. 6 is a perspective view of a test tube according to another embodiment.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated. The words “a” or “an” are to be taken to include both the singular and the plural. Conversely, any reference to plural items shall, where appropriate, include the singular.

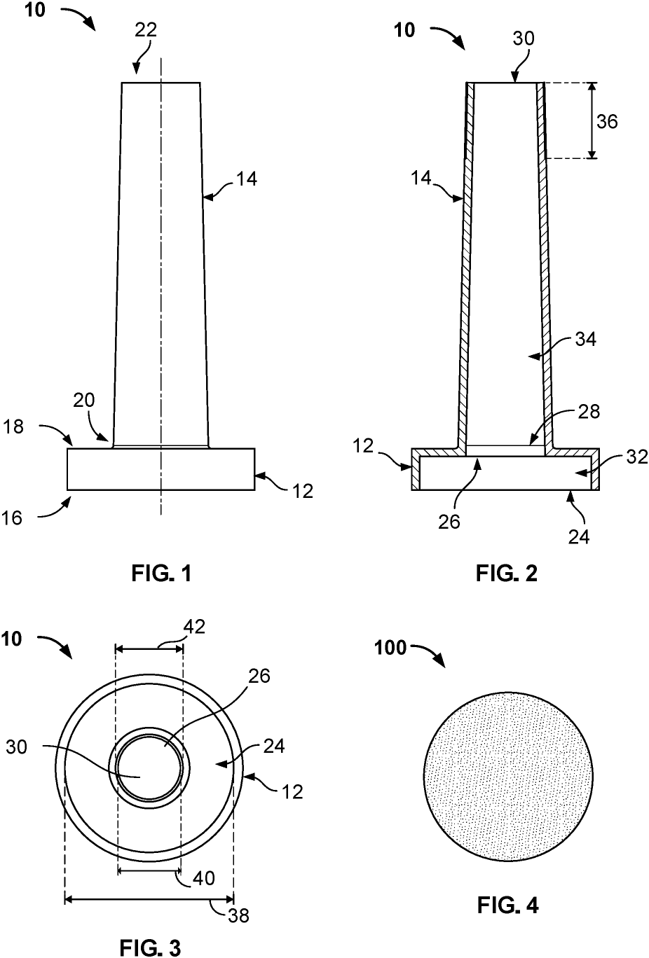

Referring now to the figures, FIGS. 1-6 show a test tube 10 according to multiple embodiments. Test tube 10 may include a base portion 12 and an elongated tubular portion 14.

FIG. 1 shows a side view of test tube 10. Specifically, FIG. 1 shows test tube 10 that may include base portion 12 and elongated tubular portion 14. Base portion 12 may include a first end 16 and second end 18. Elongated tubular portion 14 may include a third end 20 and fourth end 22. Elongated tubular portion 14 and base portion 12 may be a tubular structure with a hollow interior to allow fluid to enter through fourth end 22 and flow through elongated tubular portion 14 into base portion 12 through third end 20 and second end 18. Base portion 12 may be configured to provide stability and support the elongated tubular portion 14 in an upright position, and first end 16 is placed on a surface, for example, a table, and the elongated tubular portion 14 is arranged on top of the base portion 12 away from the surface. In an embodiment, the elongated tubular portion 14 may be configured to taper from the third end 20 toward the fourth end 22 as shown in FIGS. 1-2, which may further improve stability of the test tube 10 when in an upright position for testing.

FIG. 2 show a cross-sectional view of test tube 10. Base portion 12 may include a first opening 24 near first end 16, second opening 26 near second end 18, and first interior section 32. Elongated tubular portion 14 may include a third opening 28 near third end 20, fourth opening 30 near fourth end 22, second interior section 34, and outer section 36 near fourth opening 30. First interior section 32 is the interior section of base portion 12 having a diameter. Second interior section 34 is an interior section of elongated tubular portion 14 having a diameter.

In an embodiment, base portion 12 may include a tubular structure with a first interior section 32 having a diameter greater than or equal to a diameter 38 of the first opening 24. In another embodiment, base portion 12 may include a tubular structure with a first interior section 32 having a diameter equal to a diameter 38 of the first opening 24.

In an embodiment, elongated tubular portion 14 may include a tubular structure with a diameter of second interior section 34 less than a diameter of first interior section 32 of the base portion 12.

In an embodiment, elongated tubular portion 14 and base portion 12 may have a wall made out of a translucent material that allows a user to see the fluid within test tube 10.

In an embodiment, outer section 36 may include a rough finish or textured section configured to provide an improved grip, fingerprint-free area, and/or optical transparency. For example, outer section 36 may be positioned at the top of the elongated tubular portion 14 near the fourth opening 30. In another example, outer section 36 may be positioned near the middle of the elongated tubular portion 14 between third end 20 and fourth end 22. In another example, outer section 36 may be located away from the third end 20.

In an embodiment, the outer section 36 may be about 12.7 mm to about 25.4 mm, preferably about 17.8 mm long.

In an embodiment, third opening 28 may be coupled to second opening 26 such that the openings align.

In an embodiment, test tube 10 may be formed as a single-piece device, wherein second opening 26 and third opening 28 may be defined by a single opening.

FIG. 3 shows a bottom view of test tube 10. Test tube 10 may include base portion 12, with first opening 24 having a first diameter 38 and second opening 26 having a third diameter 42. The test tube 10 may include elongated tubular portion 14 (not shown), with fourth opening 30 having a second diameter 40.

FIG. 4 shows a test sample 100 according to an embodient. Test sample 100 may be formed from an ostomy skin barrier material. Test sample 100 may be cut into a circular specimen for inserting into base portion 12.

Test sample 100 may be configured to be contained in first interior section 32. In an embodiment, test sample 100 may be configured to have a diameter approximately equal to first diameter 38 and a thickness less than a height of first interior section 32, such that test sample 100 may be contained within interior section 32 and does not protrude beyond first end 16 even after expansion from fluid absorption. In another embodiment, test sample 100 may be configured to have a diameter less than first diameter 38 and greater than third diameter 42, and a thickness less than a height of first interior section 32. The test sample 100 may be arranged in first interior section 32 to cover second opening 26. For example, test tube 10 may be configured to have first diameter 38 of about 25 mm to about 35 mm and third diameter 42 of about 8 mm to about 20 mm, and test sample 100 may be configured to have a diameter of about 10 mm to about 35 mm. In an embodiment, test tube 10 may be configured to have first diameter of about 31.4 mm and third diameter 42 of about 15 mm, and test sample 100 may be configured to have a diameter of about 25 mm.

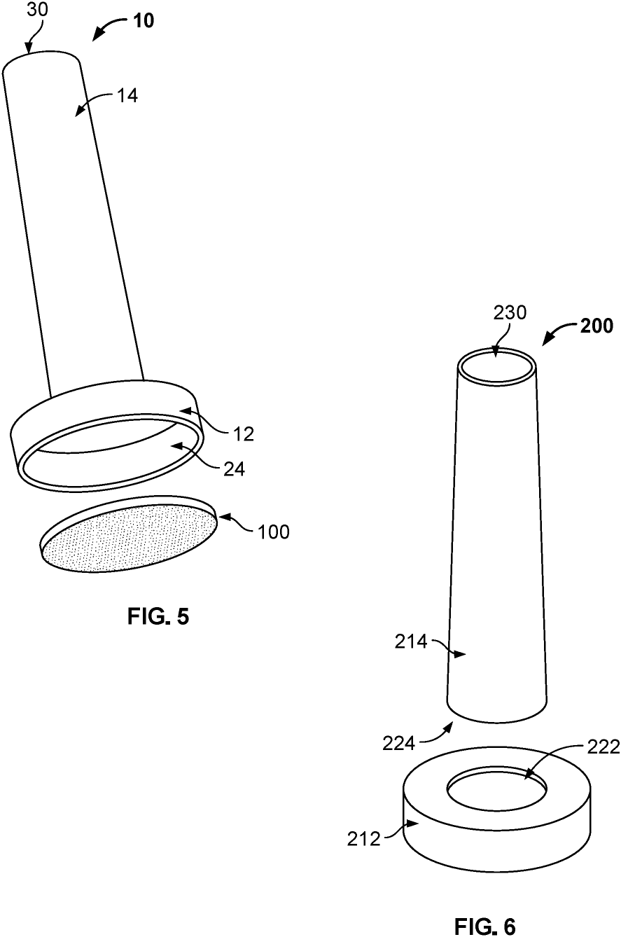

FIG. 5 shows a bottom, side view of test tube 10 with test sample 100 adjacent to first opening 24.

In an embodiment, test sample 100 may be inserted into the first opening 24 of base portion 12. Base portion 12 may contain the test sample 100 and support the elongated tubular portion 14 in an upright position. Test sample 100 may be cut to fit securely into the first opening 24 and not allow fluid to leak out. In an embodiment, test sample 100 may be formed from an adhesive skin barrier material and arranged in the base portion 12, such that test sample 100 is adhesively attached to an inner surface of base portion 12 around second opening 26. This way a test fluid may be filled through fourth opening 30 of elongated tubular portion 14 and contained in elongated tubular portion 14 and make contact with test sample 100 without leaking out of base portion 12.

In an embodiment, test tube 10 may be configured for testing fluid absorption of an adhesive skin barrier material according to a test method, such as ISO 12505-1. In such an embodiment, test tube 10 may include elongated tubular portion 14 configured to contain about 5 ml to about 15 ml of test fluid, preferably at least about 10 ml, and base portion 12 configured to stably support the test tube 10 in an upright position and to receive test sample 100 having a diameter of about 25 mm. The test fluid may be suitable liquid, such as 0.9% saline solution. In such an embodiment, test tube 10 may be configured to have the first diameter 38 of about 31.37 mm, the second diameter 40 of about 12.57 mm, and the third diameter 42 of about 15 mm. Test tube 10 may be formed as a single-piece device using a suitable polymeric material, such as polycarbonate.

For the fluid absorption test, a subject barrier material may be cut into a circular specimen having a diameter of 25 mm to prepare the test sample 100. Test sample 100 may be placed in base portion 12 to cover a lower opening of the elongated tubular portion. Test sample 100 may be attached to an inner surface of the base portion 12 around the second opening 26. Test tube 10 may be vertically arranged, such that test tube 10 may be standing on base portion 12. Elongated tubular portion 14 may be filled with a test liquid according to the test method to test the fluid absorption of test sample 100.

In some embodiments, test tube 10 may be configured to provide an increased contact between test sample 100 and the test fluid in test tube 10 by providing second opening 26 having an increased diameter.

Test tube 10 may be formed from a transparent material, such as polycarbonate, for optical transparency and may include a textured area for improved grip and fingerprint-free grip while maintaining conformance with the test standards.

Test tube 10 may have a built-in stand that allows the test tube to stand on its own. For example, the built-in stand may be base portion 12 or another structure that may support elongated tubular portion 14 in an upright position.

FIG. 6 shows a side view of test tube 200 according another embodiment. Test tube 200 may be configured similar to test tube 10 of FIGS. 1-5, including an elongated tubular portion 214 and a base portion 212, except elongated tubular portion 214 and base portion 212 are formed as two separate members and assembled together to form test tube 200 in this embodiment. Base portion 212 may include a first opening 222 and elongated tubular portion 214 may include an end 224 and second opening 230. First opening 222 and end 224 may be connected using a connecting structure. For example, the openings may be connected using a screw like structure, pressure structure, adhesive, or a separate structure that connects the openings together.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A test tube for testing fluid absorption of a sample material comprising:
an elongated tubular portion configured to contain a test fluid; and
a base portion in fluid communication with the elongated tubular portion and configured to support the elongated tubular portion when the test tube is in an upright position with the base portion placed on a surface, the base portion configured to receive and contain the sample material;
wherein the test tube is configured such that when the sample material is received in the base portion and the test tube is placed in the upright position for a fluid absorption test, the test fluid contained in the elongated tubular portion makes contact with the sample material.

2. The test tube of claim 1, wherein the base portion comprises a first end and a second end, wherein the first end comprises a first opening for receiving the sample material, wherein the second end comprises a second opening, wherein a diameter of the second opening is less than a diameter of the first opening, wherein the elongated tubular portion comprises a third end with a third opening and a fourth end with a fourth opening, wherein the second end is coupled to the third end, and wherein a diameter of the fourth opening is less than a diameter of the first opening.

3. The test tube of claim 2, wherein the fourth opening is configured to allow the test fluid to enter the elongated tubular portion and to flow to the base portion through the second and third opening.

4. The test tube of claim 2, wherein the base portion includes an inner surface radially extending from and surrounding the second opening, the inner surface configured for attachment of the sample material, wherein the sample material is attached to the inner surface and covers the second opening when the sample material is received in the base portion, wherein the test fluid contained in the elongated tubular portion makes contact with the sample material through the second opening.

5. The test tube of claim 2, wherein the base portion and the elongated tubular portion are integrally formed as a single-piece device, wherein the second opening and the third opening are formed as a single continuous opening.

6. The test tube of claim 2, wherein the base portion comprises a tubular structure with a diameter greater than or equal to the diameter of the first opening.

7. The test tube of claim 2, wherein the first opening is a substantially circular opening and the sample material has a substantially circular body, wherein a diameter of the first opening is greater than or equal to a diameter of the sample material.

8. The test tube of claim 2, wherein a surface of the elongated tubular portion comprises a textured area for improving grip.

9. The test tube of claim 8, wherein the textured area is located away from the third end.

10. The test tube of claim 1, wherein the elongated tubular portion comprises a tubular structure with an interior diameter less than an interior diameter of the base portion.

11. The test tube of claim 1, wherein the elongated tubular portion is configured to hold at least about 10 ml of the test fluid.

12. The test tube of claim 1, wherein the elongated tubular portion is supported by the base portion in an upright position and wherein the test fluid in the elongated tubular portion makes contact with the sample material without leaking out of the base portion.

13. The test tube of claim 1, wherein the sample material is formed from an ostomy skin barrier material.

14. The test tube of claim 1, wherein the test tube is formed from polycarbonate.
